(19) United States
(12) Patent Application Publication
(10) Pub. No.: US 2008/0266595 A1
(43) Pub. Date: Oct. 30, 2008

(54) Independently-addressable cellular wireless digital network-based fax machine

(76) Inventors: Christopher Wright, (US); Joseph H. Wright, Toronto (CA)

Correspondence Address: DERGOSITS & NOAH LLP, FOUR EMBARCADERO CENTER, SUITE 1450, SAN FRANCISCO, CA, 94111, US

(21) Appl. No.: 11/900,539

(22) Filed: Sep. 11, 2007

Related U.S. Application Data
(60) Provisional application No. 60/843,936, filed on Sep. 11, 2006.

(51) Int. Cl. G06F 3/12; H04N 1/32; G06F 15/00

(52) U.S. Cl. 358/1.15; 358/1.13; 358/468; 455/556.1

(57) ABSTRACT

A fax machine incorporates a receptacle to accommodate the insertion of a cellular data access modem that provides the fax machine with a unique cell phone number so that the fax machine may be accessed in a standard “dial up manner” from any standard fax machine or computer emulating a fax machine.

### CROSS REFERENCE TO RELATED PATENT APPLICATIONS

The present application claims priority to US Provisional Patent Application “Independently-Addressable Cellular Wireless Digital Network-Based Fax Machine,” Serial No. 60/843,936 which was filed Sep. 11, 2006.

### FIELD OF INVENTION

The invention relates to fax machines that utilize cellular wireless digital communications networks and services.

### BACKGROUND

Fax machines are usually large immobile devices consisting of an image scanner, a modem, and a printer combined into a single housing. The scanner converts the content printed on a physical document into a digital image, the modem sends the image data over a phone line. The image data is received by the modem of the receiving fax machine and the printer produces a copy of the transmitted document. Some fax machines can perform multiple functions with the individual components and can be used independently. For example, the fax machine can be connected to a computer printer and the scanner can provide digital images of scanned papers to the computer.

Fax machines are normally hard-wired to telephone company communications land lines and are typically placed in locations where they can be conveniently connected to a phone line. The fax machine can have a dedicated phone line and a unique telephone number. Alternatively, the fax machine can share the phone line and phone number with a telephone, computer, and other devices. Some multi-function systems can differentiate voice phone calls from fax data transmissions so that the correct hardware is automatically actuated.

Fax machines are not thought of as either portable or mobile devices because of their requirement to be installed in a location where access to a land line is available. Although there are other systems that can send and receive faxes through computers and the internet, these systems may be the best method for transmitting highly confidential information because of the inherent security weaknesses of the internet. Information that is faxed between computers over the internet is stored in the computer memory. Hackers may then access the computers and obtain the stored fax information.

What is needed is a more convenient secure system for receiving and transmitting mobile fax communications.

### SUMMARY OF THE INVENTION

The invention is directed towards a mobile fax system that allows users to transmit and receive faxes via cell phone networks. In an embodiment, the inventive fax system is a portable unit having a cell phone transceiver that gives the user a dedicated fax phone number. The cell phone transceiver can be built into the fax machine housing or into a module that plugs into the fax machine. The connection between the transceiver and the fax machine can be a wired or wireless connection that allows communications between the transceiver and the fax machine. Examples of wireless communications include wireless personal area network (WPAN) technologies.

In the removable module embodiment, the transceiver is built into the module and provides wireless communications capabilities to any compatible fax machine. Because the transceiver module is very small, the user can travel with just the module and plug it into any compatible machine to create a secure and private fax machine. Because the communications are through a cell phone service network rather than the Internet, the information is more likely to be securely transmitted and much less likely to be stolen or duplicated than faxes transmitted via internet communications.

In an embodiment, the transceiver module can function independently of the fax machine and may have various additional features that improve the functionality of the inventive system. The transceiver module may include a rechargeable power supply and a memory for storing fax data. In this configuration, the transceiver module can be functional when separated from a fax machine. The user can receive and store incoming faxes while traveling with the transceiver module in any area that has cell phone service coverage. The user can then print the faxes when the module is coupled to a compatible fax machine or printer.

The transceiver module may also include a signal indicator which indicates the strength of a cell phone communications signal. If there is no signal, the system cannot transmit or receive fax information. The module may include an incoming fax indicator that informs the user when a fax has been received. The indicator can be a light or a ringer. When the indicator is actuated, the user can go to a compatible machine to print the fax. The user can also include an available memory indicator that provides a visual indication of the memory available for downloading fax information. If there is insufficient available memory the system may allow a user to delete fax data. The user may delete older faxes that have been printed so that new fax information can be received and stored.

The module may also include a control panel and a visual display that allows the user to view information about incoming, stored or transmitted faxes. The control panel may allow users to control the information displayed. The information that can be displayed may include a log of incoming, stored and transmitted faxes. The display may also show the contents of the incoming, stored and transmitted faxes. In an embodiment, the display may be a touch screen that functions as both the control panel and the visual display. In an embodiment, the module may also include a speaker. When a fax is received by the module, the system may be configured to emit an audio signal such as a ringer that indicates that a fax has been received. In other embodiments, the module may be also have a vibration mode so that the user can be silently informed that a fax has been received.

In an embodiment, the Fax machine 103 is specially constructed with an internal speaker but without a handset or microphone so that it cannot be used to initiate voice calls. This counter-intuitive action allows a new business model to be proposed in which the cell phone network provider can assign a lower subscription or service rate to a data-only fax device that cannot be used for voice calls. This lower rate may encourage the deployment of cellular network-based fax machines 103 without cannibalizing the existing rates paid by voice customers. This different price structure may be similar to how text messaging has a separate billing structure than the voice network.

### BRIEF DESCRIPTION OF THE DRAWINGS

The invention described is consistent with the Figures in the accompanying drawings.

FIG. 1 illustrates a fax machine and different communication channels to a cell network;

FIG. 2 illustrates a communications path between fax machines through a cell network;

FIG. 3 illustrates a communications path between a fax machine, transceiver module, cell phone through a cell network;

FIG. 4 illustrates system information on a visual display of a transceiver module;

FIG. 5 illustrates user options on the visual display of the transceiver module; and

FIG. 6 illustrates sub options on the visual display of the transceiver module.

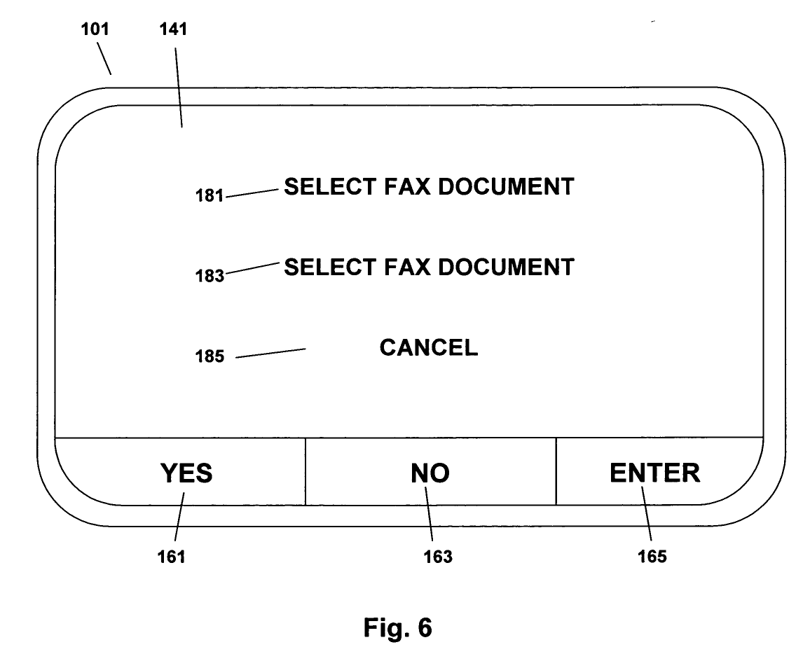

### DETAILED DESCRIPTION

The present invention is directed towards a fax communications system that can utilize wireless cell phone networks to allow for portable fax communications. With the convergence occurring in the marketplace between wired and wireless hardware and software communications products, basic stand alone fax machines and enhanced “multi-function” fax machines can be significantly improved and their usage broadened if they can be independently and uniquely addressed and accessed by and through usage of wireless cellular digital networks. The unique addressing is accomplished by assigning a dedicated phone number to the fax machine transceiver.

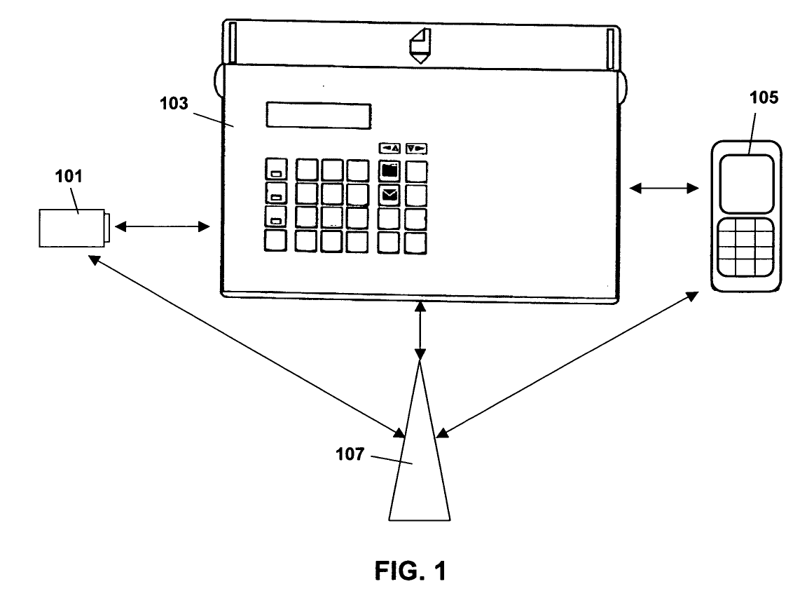

There are different ways in which fax machines can be integrated into wireless cellular digital networks. With reference to FIG. 1 in a first embodiment, specific communications protocols and capabilities for cellular wireless digital network communications are built into fax machines 103 at the time they are manufactured. In this embodiment, a specific fax machine 103 would be assigned a wireless carrier's protocol and its specific telephone number address may either be assigned at the time of manufacture or programmed into the machine at the time of its purchase by an end user. The fax machine 103 includes an integrated transceiver that allows the fax machine 103 to communicate with cell phone networks through cell network antennas 107. With the fax machine 103 coupled to the network, fax data can be transmitted to any other cellular network fax machines or land line fax machines. An independently-addressable cellular wireless digital network-based fax machine 103 may have a built-in antenna and either built in or insertable electronics in any of a number of cellular or other wireless protocols, such as UMTS, HSDPA, EV-DO, EDGE, GSM, CDMA, etc. In these embodiments, units can be simply called up and faxes can be received or calls can be made and faxes can be transmitted in the same manner as hard-wired units, almost without regard to a given machine's location. This allows fax machines to become truly portable communications devices for the first time.

In another embodiment, the fax machine 103 can be integrated into a wireless cell phone network by utilizing network modules 101 or cards that communicate with the fax machine 103. The module 101 can be inserted into a communications port in the fax machines 103. The network modules 101 incorporate the specific communications protocols (capabilities) for cellular wireless digital network communications. The transceiver modules may plug into the fax machine 103 and provide access to a cellular phone network 107. In an embodiment, the fax machine 103 that accommodates the network modules 101 can be the same or similar to standardized computer card slots. The network modules 101 may be stand-alone cards that perform all of the network access functions, or they may make use of some of the processing power of the fax machine into which they are plugged.

An example of a transceiver module 101 card and slot interface configuration is the Personal Computer Memory Card International Association (PCMCIA) card and slot that are commonly used with laptop computers. There are several types of PCMCIA cards known as type I, II, III and IV. The form factors of these cards vary in thickness with type I being the thinnest and type IV being the thickest. Many other types of module/slot interfaces exist including USB, CardBus, CardBay, ExpressCard, PC Card, CompactFlash, MiniCard, SmartMedia, etc. The transceiver module 101 may also have a unique format that is designed for a specific cellular network provider. This design would prevent users from accidentally inserting a transceiver module from one network into a fax machine configured for a different network provider. The cell phone company can promote the use of the cellular Fax system without the risk of the fax machine being swapped over to another carrier unless the customer buys a new cell phone interface module that may or may not be usable. This fortuitous result offers incoming data security that the cellular data network providers do not have with their existing cell phone users who can, in some cases, swap network providers easily by the swap of a SIM card. If a customer wants to swap carriers for his Fax, he must, at minimum, purchase a completely new cellular modem module for the Fax machine.

In an embodiment, the fax machine 103 plug in transceiver module 101 and has the ability to be preloaded with a certain amount of service value in the manner of a prepaid phone. This preload of value for service allows the fax machine 103 and transceiver module 101 to be used with no user set up or registration. The cellular service provider may also be able to send a renewal notice to the user whose balance is running low. The user can respond by printing the faxed renewal notice and filling out the notice and faxing it back to the cellular data provider to add more credit to the amount stored in the prepaid fax module. In other embodiments, the funds for the services can be automatically charged to a credit card when additional service fees are required.

In various embodiments, the transceiver module 101 and the fax machine 103 may each directly communicate with the cell network. The transceiver module 101 and the fax machine 103 may be configured to include a slot for a removable card for identifying the fax machine and/or user. The card can be a Subscriber Identity Module (SIM) card, a Universal Mobile Telecommunications System (UMTS) card, a Removable User Identity Module (RUIM) or any other similar card. The card securely stores the service-subscriber information used to identify a cell phone network subscriber. The card also has memory which is used to store some information such as identification information and a fax phone number directly.

These transceiver modules 101 can be assigned telephone number addresses either at the time of their manufacture or programmed at the time of purchase by an end user or downloaded from the cellular service provider. The transceiver module 101 may include an electronic memory that stores the telephone number and an electronic serial number for the module. In an embodiment the transceiver module 101 may be a part of the user's cell phone. The phone may have two or more phone numbers including at least one phone number for the fax and at least one other phone number for the cell phone.

Fax machines communicate using their own digital formats and include digital compression methods to reduce the fax data transmission times. Several different telephone line modulation techniques are used by transceiver modules which are negotiated during the initial fax-modem handshake. The transceiver modules will use the highest data rate that both devices support. Some additional time is required for the transceiver modules to handshake and synchronize. The horizontal and vertical resolutions can vary among different fax resolution levels. The resolution is typically based upon the number of scan lines per inch. The number of horizontal and vertical scan lines can range from 100 to greater than 400 lines per inch.

The operations of cell phone networks vary significantly from provider to provider, and country to country. However, all cell phones communicate through electromagnetic radio waves with a cell site base station, the antennas of which are usually mounted on a tower, pole or building. The inventive system uses a low-power cell phone transceiver in the transceiver module 101, fax machine 103 or cell phone 105 that transmits fax data to the cell phone antenna 107. The range of the transmissions is usually not more than 5 to 8 miles.

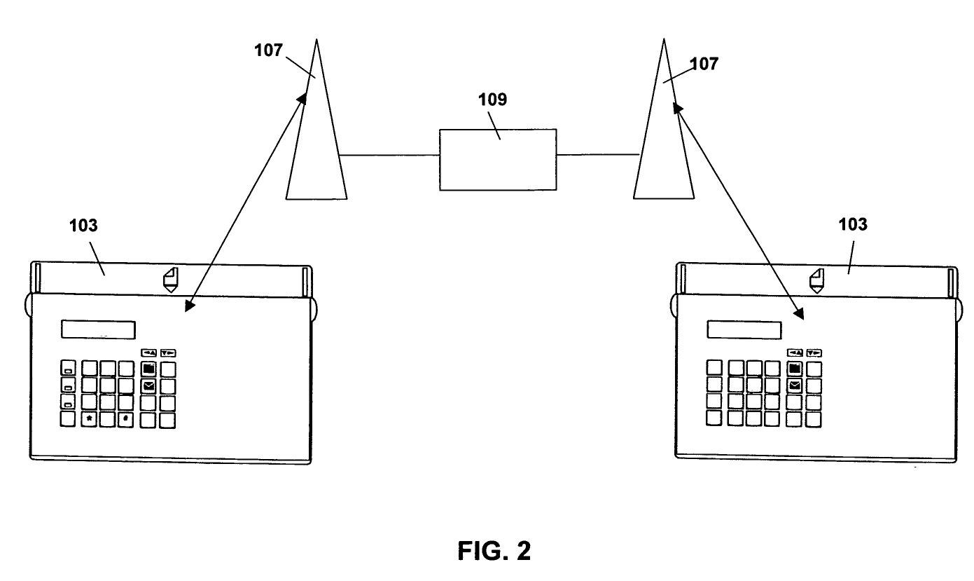

With reference to FIG. 2, in an embodiment the inventive system transmits fax data by first scanning a fax document and converting the scan into a digital representation of the scanned image. The fax machine 103 then transmits fax data to the cell network antenna 107; the fax data is routed through the cell network 109 and is transmitted from a cell phone antenna 107 to the receiving fax machine 103. The receiving fax machine 103 can store the fax data in memory or immediately print the fax data onto paper. In an embodiment, the fax machines 103 also encrypt the fax data. The sending fax machine 103 can encrypt the fax data so that data transmitted through the cell network 109 is secure and anyone who tries to intercept the fax data will not be able to interpret the fax data. The receiving fax machine 103 receives the encrypted fax data and performs the decryption before printing.

Although the fax machine 103 is small and portable, it can still be cumbersome to travel with. For improved mobility, the transceiver module 101 can be used to send and receive fax data without the fax machine 103. For example, an end user may use a specific transceiver module 101 unit at his or her office, take it home, or take it on a trip. Wherever it is located, that transceiver module 101 unit's cellular telephone number address will remain the same. Or, a user may have several machines (incorporating insertable transceiver modules 101 or cards) that are located in different places. In this case a transceiver module 101 or card may be moved from one machine to another, allowing the machine's cellular carrier's protocol and address to move with the transceiver module 101 or card to the unit into which it is installed. Proximity to a land line is no longer an issue. A Fax machine 103 and the capabilities it provides to end users can be located just about anywhere in an office or home or other location

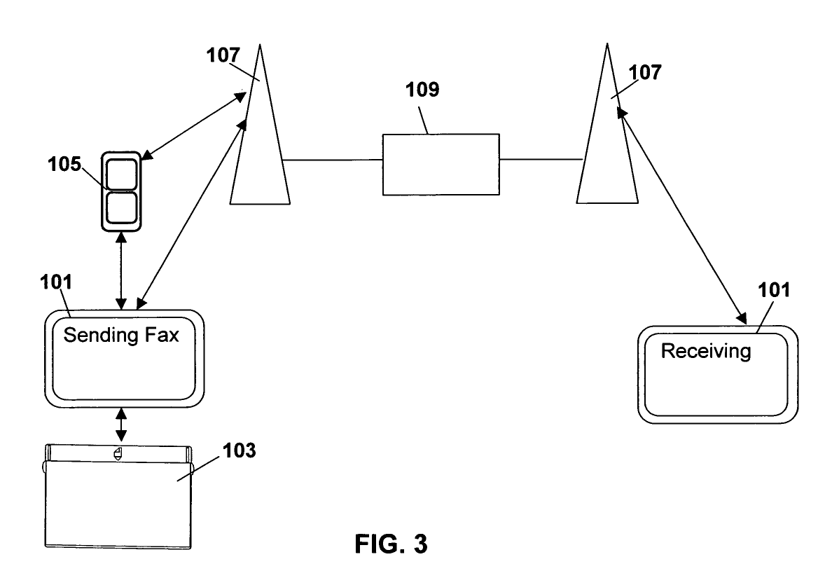

With reference to FIG. 3, in an embodiment, the transceiver module 101 can be battery operated so that it can be used alone or with the cell phone 105 to transmit and receive fax data. The transceiver modules 101 and cell phone 105 can be carried with the users so that fax data can be transmitted and received while the users are moving. Cell sites have relatively low-power radio transmitter antennas 107 which broadcast their presence and relay communications between the transceiver modules 101 or cell phones 105 and the mobile exchange 109. When the transceiver modules 101 and cell phone 105 are turned on, the user's transceiver module 101 or cell phone 105 transmits information through the cell network antenna 107 and registers with a mobile exchange 109 that requests access and authentication. The transceiver modules 101 or cell phone 105 responds by providing the unique identifiers. The operator exchange 109 searches its database for the identifiers provided. If the identification is authenticated and the transceiver module 101 or cell phone 105 is granted access to the cell network 109. The dialogue between the transceiver module and the cell site is a stream of digital data that includes digitized audio (except for the first generation analog networks). The mobile communications protocol can be digital GSM, CDMA, TDMA, WCDMA, CDMA2000 EV-DO, or TD-SCDMA standard. Each network 109 has a unique radio frequency band.

In an examplary system, the fax data is transmitted from the transceiver module 101 to the cell phone 105. The cell phone 105 then transmits the fax data to a cell network antenna 107 and the fax data is transmitted through the cell network 109. The fax data is routed to the network antenna 107 and wirelessly transmitted to the receiving transceiver module 101. In the example, the receiving transceiver module 101 can receive fax data without a cell phone. In an embodiment, the system may also encrypt all further communications between the fax machine 103 and the cell network 109 to enhance the security of fax communications. The transceiver module 101, fax machine 103 or cell phone 105 can encrypt the fax data to enhance the security of the fax communications.

When the transceiver module 101 or cell phone 105 receives fax data it may will then be alerted by the mobile exchange 109 when there is an incoming fax. The transceiver module 101 or cell phone 105 monitors for the strongest signal being received from the surrounding base stations. As the user moves around the cell network, the transceiver module 101 may “handoff” to various cell sites during incoming or outgoing fax transmissions, or while waiting (idle) between faxes it can select the strongest cell sites.

In order for the inventive fax system to scan and print fax data, the transceiver modules O1 must have a communication interface with the fax machine 103 and cell phone 103. The interface can be a wired Universal Serial Bus (USB) connection which can be coupled to the fax machine 103 and cell phone 103. In other embodiments, the transceiver modules 101 can be connected to a personal computer (PC), a printer interface to a PC, PDAs, hand held PCs, local network connections, etc.

While the connection to the transceiver module can be any wired connection, it can also be a wireless connection that is established when the transceiver module is placed in close proximity to the fax machine. This type of wireless network communications is known as a personal area network (PAN). Examples of PANs include Infrared Data Association (IrDA) which is a physical communications protocol standars for the short-range exchange of data over infrared light light. The module may also communicate with the main fax machine via radio frequency standards such as BlueTooth. Local Bluetooth adapters convert a USB output of a computer to a broadcast Bluetooth signal and Bluetooth adapters that convert a broadcast Bluetooth signal to an analog signal, an Apple iPod digital signal, or back to a USB signal are also well known on the market. For example, the BUA-100 adapter sold by Verifone converts a USB signal to Bluetooth at the base unit and in the remote unit converts the Bluetooth signal to an analog signal for use in a headphone. WiFi can also be used by the inventive system to facilitate communications between the transceiver module 101 and the fax machine 103 or other digital devices.

Additionally, cellular networks 109 may store incoming fax communications on the network for later (future) delivery. This feature is particularly useful when a specific cellular fax machine 103 is either not turned on or not connected to the network 109, or is occupied with another communication over the network 109. The fax data sender may be notified by the network provider that documents are waiting in a queue for delivery to the recipient fax machine 103. Once the fax machine 103 is connected to the network 109, it can access and print and/or forward the fax documents that have been stored by the network provider.

A fax machine 103 incorporates a specific communications protocol (capability) for cellular wireless digital network communications (like HSDPA, UMTS, EV-DO, EDGE, GSM, CDMA, Etc) built into and programmed into the fax machine 103 at the time of its manufacture. The fax machine 103 is assigned a wireless carrier's cellular network protocol at the time of manufacture and its specific cellular telephone number address may either be assigned to the fax machine 103 at the time of manufacture or programmed into the machine at the time of its purchase and/or lease by a customer.

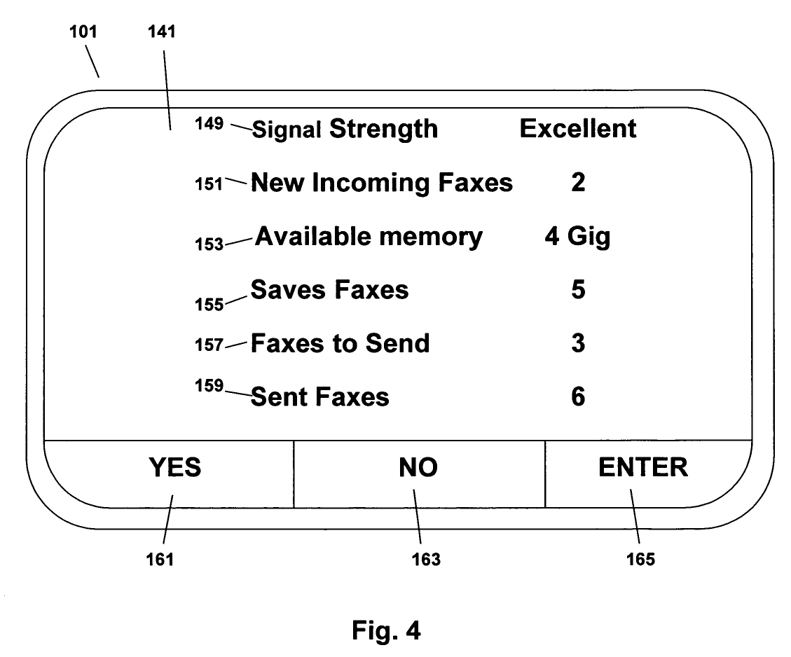

With reference to FIG. 4, the transceiver module 101 may also include various displays and controls that allow a user to control the operation of the module 101 when it is disconnected from the fax machine 103. The transceiver module 101 may have a visual display 141 that provides system information to the user. The transceiver module 101 may include a signal indicator 149 which indicates the strength of a cell phone communications signal. The user will know that if there is no signal strength, the transceiver module 101 cannot transmit or receive fax information. The transceiver module 101 may include an incoming fax indicator 151 that informs the user when faxes has been received. The incoming fax indicator can also be a light or a ringer. When the indicator 151 is actuated, the user can go to a compatible machine to print the fax. The user can also include an available memory indicator 153 that provides a visual indication of the memory available for downloading fax information. If there is insufficient available memory the system may allow a user to delete fax data. The indicator may specify the number of saved faxes 155, the number of faxes to send 157 and the number of sent faxes 159. The user may delete older faxes that have been printed or faxes that the user has decided not to send, so that new fax information can be received and stored.

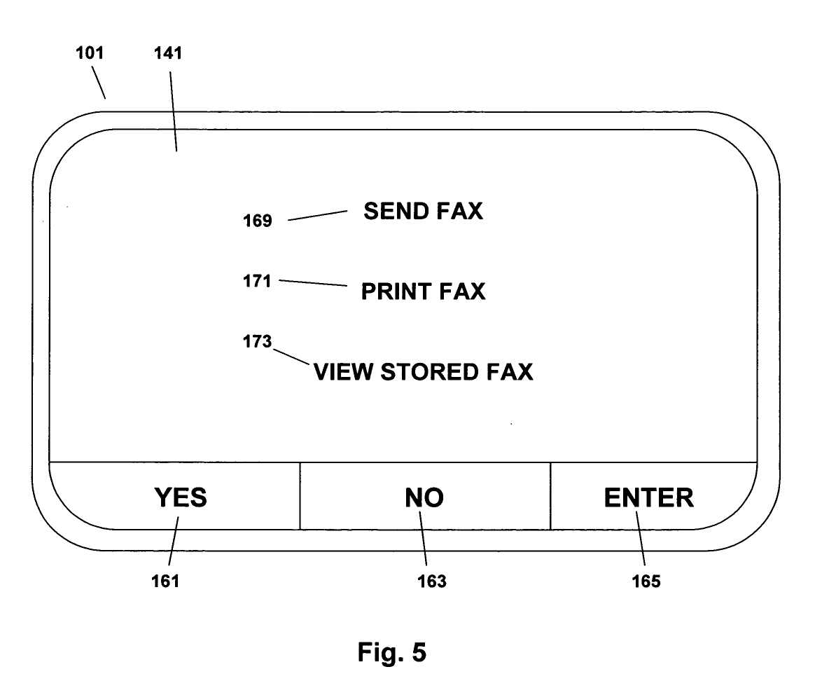

The transceiver module 101 may also include control buttons that the user can actuate in response to prompts from the device. The control buttons can include “YES” 161, “NO” 163 and “ENTER” 165. With reference to FIG. 4, the system can provide a menu of control options such as send fax 169, print fax 171 and view stored fax 173. With reference to FIG. 5, if the user selects the send fax function, the transceiver module 101 may provide sub options that ask if the user to select a fax document 181 and select a fax number to send the document 183 or cancel the action 185. In response to these prompts, the user can select the desired information and press the enter button 165. In an embodiment, the display 141 is a touchscreens that has the ability to display and receive information on the same screen. Thus, the options are displayed and the user can select the desired option by touch.

The transceiver module obtains power from batteries which can be recharged from a main fax power supply, a USB port or a cigarette lighter socket in a car. In an embodiment, the portable fax machine and/or transceiver module use nickel metal-hydride which have a low size and weight. Alternatively, lithium-ion batteries can be used. Lithium ion batteries are lighter and do not have the voltage depression that nickel metal-hydride batteries do. Another suitable type of battery is lithium-Polymer batteries which have lower weight than Lithium-Ion and can be formed into various shapes and may conform to the housing of the transceiver module.

As discussed in the background, there are some Internet fax systems that are available, however these systems are generally not secure because information is frequently stored on computers that are vulnerable to attack from other computer users. In contrast, the inventive system utilizes cell phone communications which are more secure. In addition to the security of the cell phone network, it is also possible to encrypt the fax data to further improve the security of the system. The fax data encryption can be performed by encryption hardware coupled to or integrated into the transceiver module. The encryption hardware must be installed in both the transmitting and receiving transceiver devices.

It will be understood that although the present invention has been described with reference to particular embodiments, additions, deletions and changes could be made to these embodiments, without departing from the scope of the present invention. Although a method has been described that includes components and process steps, it is well understood that these components and methods can be modified and rearranged in various other configurations and processes.

What is claimed is:

1. A fax system comprising:
a housing;
a scanner mounted within the housing for scanning images;
a printer mounted within the housing for printing fax data on paper;
a control panel mounted on an exterior surface of the housing for controlling the operation of the fax system;
a removable transceiver module that communicates with cell network and includes a transceiver, a rechargeable batter and a memory for storing fax data; and.
a connector in the housing for connecting the removable transceiver module to the scanner and the printer.

2. The fax system of claim 1 wherein the module further comprises a removable identification card.

3. The fax system of claim 1 wherein the removable transceiver module further comprises a visual display.

4. The fax system of claim 3 wherein the visual display is a touch screen input device.

5. The fax system of claim 1 wherein the transceiver module includes a controller that emits an output signal when the fax data is received.

6. The fax system of claim 1 wherein the transceiver module further comprises a speaker.

7. A transceiver module for use with a fax machine comprising:
a cell phone transceiver for transmitting and receiving fax data;
a memory for storing the fax data;
a power supply;
a communications mechanism for transmitting the fax data to the fax machine;
a control panel for controlling the operation of the portable module; and
a display for providing information about the fax data.

8. The transceiver module of claim 7 wherein the visual display is a touch screen input device.

9. The transceiver module of claim 7 further comprising a controller that emits an output signal when the fax data is received.

10. The transceiver module of claim 7 wherein the communications mechanism is a cable that connects the transceiver module a fax machine.

11. The transceiver module of claim 7 wherein the communications mechanism is a personal area network transceiver that connects the transceiver module a fax machine.

12. A fax system comprising:
a fax machine;
a removable transceiver module includes a connector for connecting the removable transceiver module to the fax machine;
a cellular communications network;
wherein the fax machine scans a document and converts the document to fax data that is transmitted through the transceiver module to the cell network.

13. The fax system of claim 12 further comprising:
a second fax machine coupled to the cell network;
wherein the fax data is transmitted from the cell network to the second fax machine.

14. The fax system of claim 12 further comprising:
a second removable transceiver module coupled to the cell network;
wherein the fax data is transmitted from the cell network to the second removable transceiver module.

15. The fax system of claim 14 wherein the second removable transceiver module includes a transceiver, a rechargeable batter and a memory for storing the fax data.

16. The fax system of claim 14 wherein the second removable transceiver module includes a display that indicates that the fax data is stored in the memory.

17. The fax system of claim 16 wherein the display is a touch screen that is an input device.

18. The fax system of claim 16 wherein the second removable transceiver module includes a speaker that emits a sound indicating that the fax data is received by the transceiver.

19. The fax system of claim 16 wherein the display includes a signal strength indicator representing a strength of a signal strength of the cellular communications network.
